(19) United States
(12) Patent Application Publication
(10) Pub. No.: US 2014/0113696 A1
(43) Pub. Date: Apr. 24, 2014

(54) Game of chance

(71) Applicant: Jeff D. Myers, Phoenix, AZ (US)

(72) Inventor: Jeff D. Myers, Phoenix, AZ (US)

(21) Appl. No.: 13/998,285

(22) Filed: Oct. 18, 2013

Related U.S. Application Data
(60) Provisional application No. 61/795,488, filed on Oct. 18, 2012.

(51) Int. Cl. A63F 13/00

(52) U.S. Cl. CPC A63F 13/00
USPC 463/16

(57) ABSTRACT

A computer system to play a game of chance comprises a screen display a grid comprised of a plurality of dots; a data entry system to select a plurality of connecting lines; a payment system to pay to the selected plurality of connecting lines; and, a program to randomly pick adjacent dot pairs each to be connected by a different one of the connecting lines.

This application claims priority based on U.S. Provisional Patent Application Ser. No. 61/795,488 filed Oct. 18, 2012.

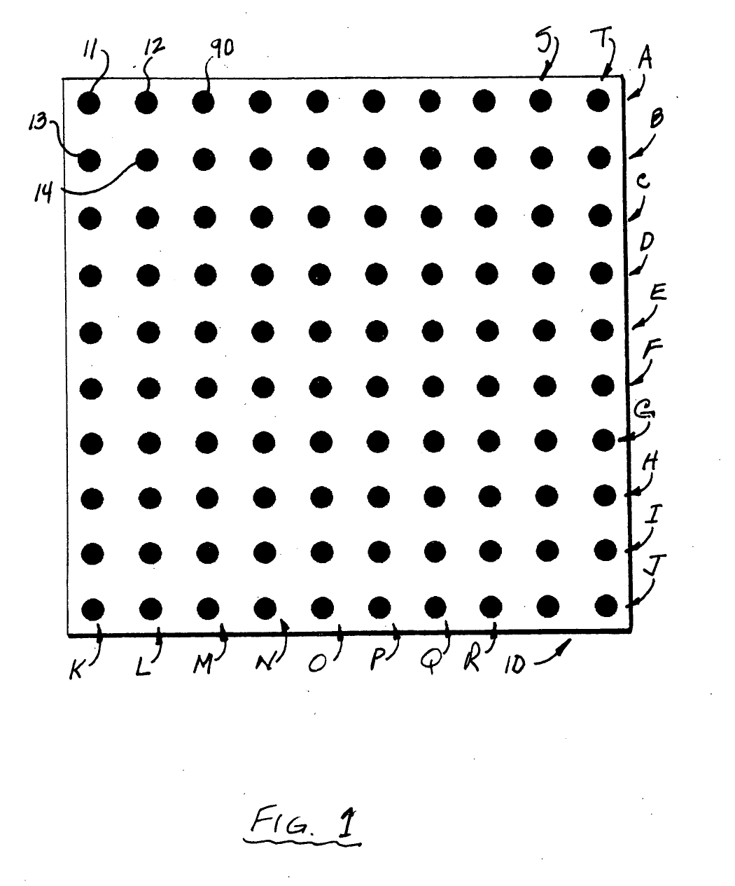

This invention pertains to a game of chance. The game is explained with reference to the attached FIGS. 1 to 5.

Gambling casinos offer a variety of computerized games. Blackjack and poker can, for example, be played on a computer.

FIG. 1 is a front view of a display screen provided with spaced apart dots in accordance with the invention.

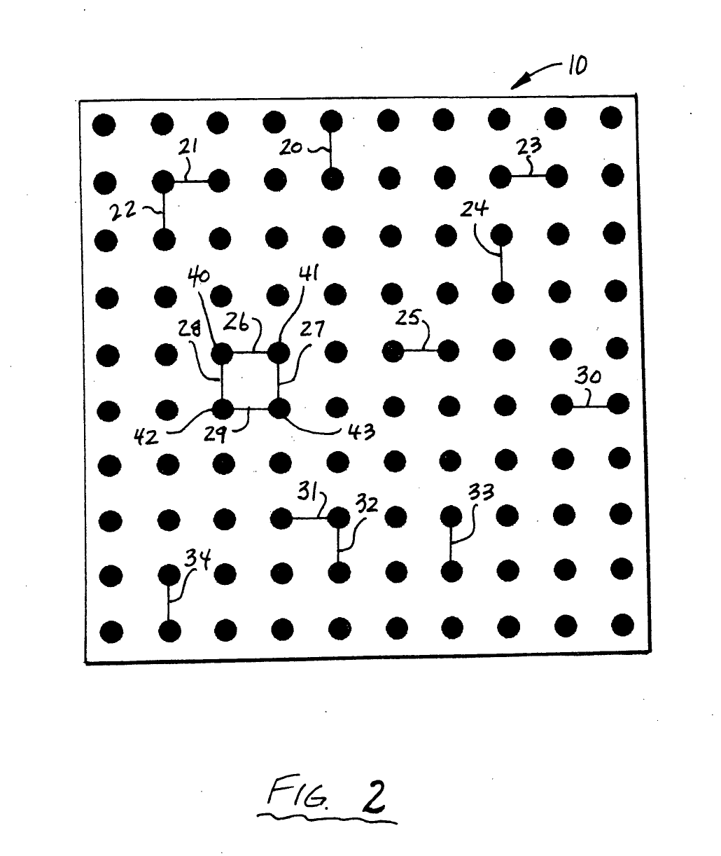

FIG. 2 is a front view of the display screen of FIG. 1 after connecting lines have appeared on the screen.

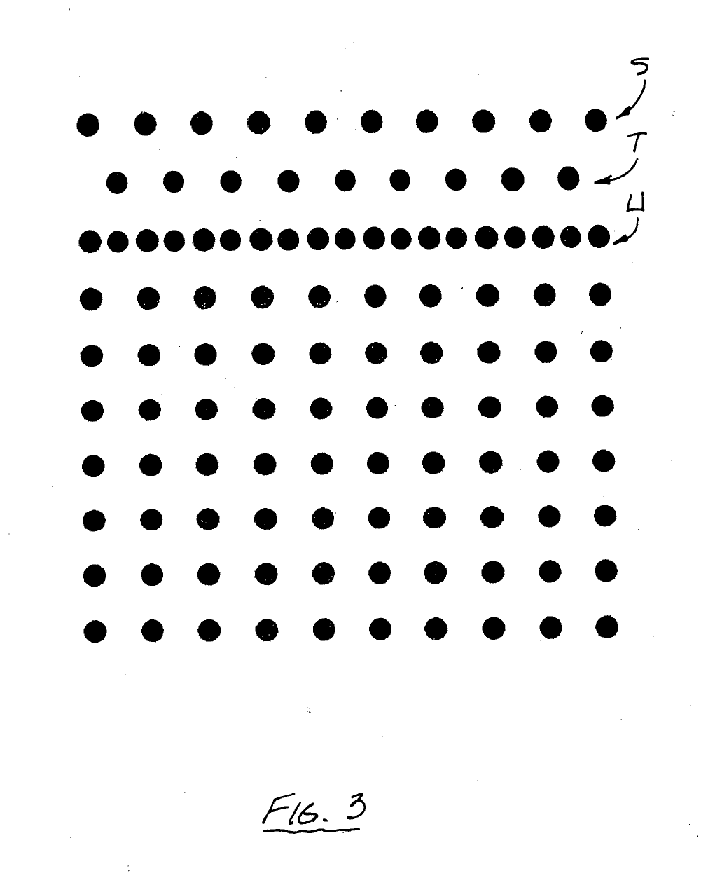

FIG. 3 is a front view of a display screen provided with dots which are spaced apart varying distances.

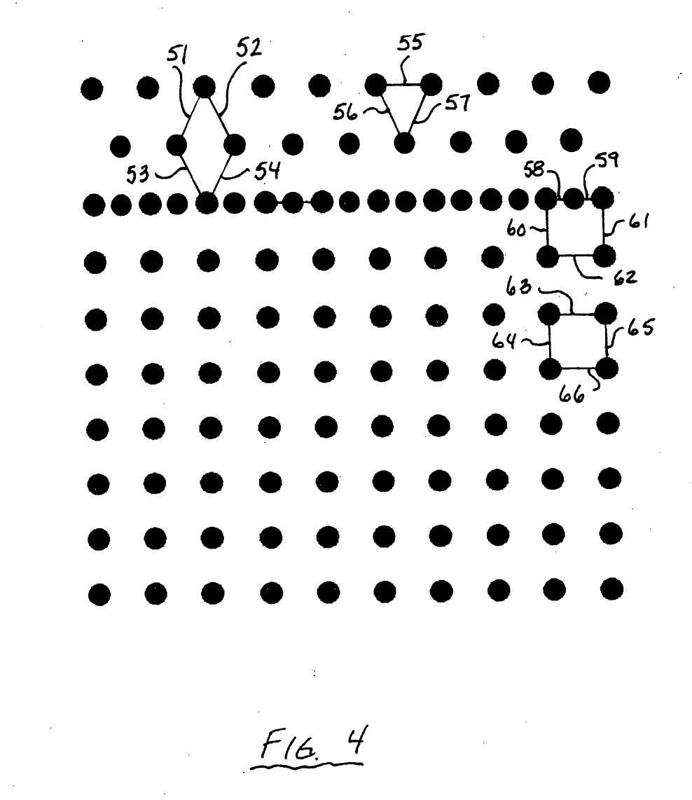

FIG. 4 is a front view of the display screen of FIG. 3 after connecting lines have appeared on the screen.

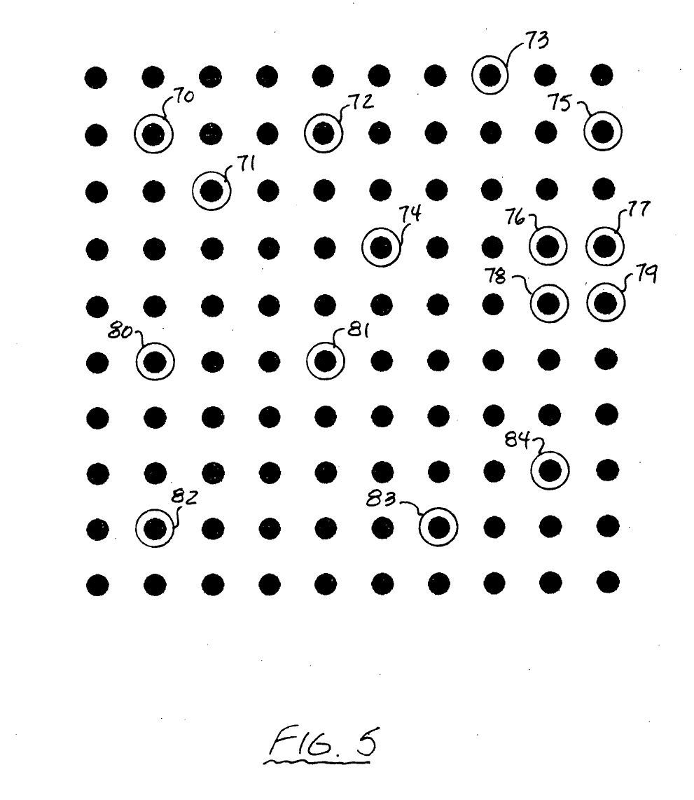

FIG. 5 is a front of a display screen provided with dots, some of which have been selected by encircling the dots.

According to my new game of chance, a grid of dots 11 to 14 is presented on a display screen 10 of a game computer. To play the game, a player selects a number of “connecting lines” which the computer will use to connect randomly selected adjacent pairs of dots. The greater the number of connecting lines selected by the player, the greater the amount of money which must be deposited in the game computer to play the game. For example, if the player utilizes a keyboard or other data entry means to select five connecting lines, then the player might be required to deposit ten cents in the computer; if the player selects ten connecting lines then the player may be required to deposit twenty centers in the computer, if he selects 20 connecting lines then he may be required to deposit fifty cents; and so on.

After the player selects and pays for a desired number of connecting lines, the game computer automatically randomly selects pair of adjacent dots to interconnect with “connecting lines” and causes the connecting lines to appear at appropriate spots on the display which appears on the screen 10 of the computer.

After viewing the display show on screen 10 in FIG. 1, it is assumed that a player utilizes a keyboard or other data input which is part of the game computer to select and pay for fifteen lines, after which the computer randomly selects fifteen pairs of adjacent dots, connects the dot pairs with the lines 20 to 34, and causes the lines 20 to 34 to appear on screen 10 in the manner depicted in FIG. 2. The player wins the game in the event four lines 26 to 29 connect four dot pairs to form a “square”. In FIG. 2, there is only one such square, the square comprised of dot pairs 20-41, 41-43, 43-42, and 42-40, which dot pairs are interconnected by lines 26 to 29, respectively. If there is one such square, the game computer awards the player with a preselected amount of money, say ten cents. If there are two such squares, the game computer awards the player with a greater amount of money, say twenty-five cents. If there are three such squares, the game computer awards the player with an event greater amount of money, say fifty cents, and so on.

Prior to programming the game computer, a casino determines what the odds are that the game computer will randomly produce one square, two squares, etc. when a certain number of connecting lines is selected by a player and, consequently, sets the amount of money (the “to play” money) that a player must pay when the player selects five lines, or ten lines, or twenty lines etc., and, sets the amount of money (the “reward” money) the player receives if the computer randomly produces one or two or three square during a game. The “to play” and the “reward” money amounts are set so that in the long term “the house” (i.e., the casino) will make a profit from individuals playing the game.

In FIG. 1, there are ten dots in each horizontal row A, B, C, D, E, F, G, H, I, J of dots. There are also ten dots in each vertical column K, L, M, N, 0, P, Q, R, S, T of dots. Dots 11 and 12 are in row A along with eight other dots. Dots 13 and 14 are in row B. Dots 11 and 13 are in column K, and dots 12 and 14 are in column L. The dots in each row A to J are each equidistant from adjacent dots in the row. For example, the distance from dot 11 to dot 12 is the same as the distance from dot 12 to dot 90. Similarly, the dots in each column K to T are each equidistant from adjacent dots in the column. Further, as can be seen, the distance between dot pairs in each column is equivalent to the distance between dot pairs in each row. Consequently, the distance from dot 11 to dot 13 is the same as the distance from dot 11 to dot 12. This need not be the case. In FIG. 3, for example, the distance between adjacent dot pairs in row U is less than the distance between adjacent dot pairs in rows S and T.

Further, in FIG. 1, each dot in a row A to J is in horizontal alignment with all of the dots in the row and in vertical alignment with all of the dots in the column in which the dot also resides, i.e., the dot grid is laid out in a checkerboard pattern. This need not always be the case. In FIG. 3 for example, each dot in row T is not in vertical alignment with a dot in row S. Each dot in row T is in vertical alignment with a dot in row U.

Further, in FIG. 2 the length of each connecting line 20 to 24 in FIG. 2 is equivalent to the length of each of the other connecting lines. This need not always be the case. In FIG. 4, for example, although the length of each connecting line 51 to 57 to equal to the length of the other connecting lines 51 to 57, the length of each line 51 to 57 is greater than the length of connecting lines 58 and 59 and 60 to 66. The length of each connecting line 58 to 59 is less than the length of each of connecting lines 51 to 57 and 60 to 66.

Further, in FIG. 1, a player wins a game if at least one enclosed geometric figure in the form of a square is formed by interconnecting four pairs of dots. The particular geometric figure which wins the game when a plurality of dots are connected can also vary. In FIG. 4 the game computer can, for example, be programmed to determine that there is a winner when a triangle is formed by interconnecting lines 55 to 57, when a square is formed by interconnecting lines 58 to 62, when a square is formed by interconnecting lines 63 to 66, or when a “diamond” shape is formed by interconnecting lines 51 to 54.

Further, in FIG. 1, a winning square is displayed by interconnecting four dots 40 to 43 with lines 36 to 29. Alternatively, a winning square can be displayed, not by using lines, but by simply circling with circles 76 to 79 (FIG. 5) the four dots necessary to form the square. Or, a winning square can be displayed by changing the color of dots 76 to 79 on the display screen, etc.

Further, in FIG. 1 circular dots are used to form a grid. The dots need not have a circular shape. Instead, some or all of the dots can each have a different shape such as a triangular shape, a square shape, a hexagonal shape, etc. Or some or all of the dots can be replaced with a small picture of a symbol or object such as a dollar sign, a picture of the head of a horse, a cherry, etc.

1. A computer system to play a game of chance comprising
(a) a screen display a grid comprised of a plurality of dots;
(b) a data entry system to select a plurality of connecting lines;
(c) a payment system to pay to said selected plurality of connecting lines;
(d) a program to randomly pick adjacent dot pairs each to be connected by a different one of said connecting lines.
